(19) United States
(12) Patent Application Publication
(10) Pub. No.: US 2002/0053408 A1
(43) Pub. Date: May 9, 2002

(54) Support hook for holding and supporting supplemental window decorations

(76) Inventor: Rosa Lee Zvonik, Sarasota, FL (US)

Correspondence Address: HAHN LOESER & PARKS, LLP, TWIN OAKS ESTATE, 1225 W. MARKET STREET, AKRON, OH, 44313, US

(21) Appl. No.: 09/891,152

(22) Filed: Jun. 25, 2001

Related U.S. Application Data
(63) Continuation of application No. 09/178,655, filed on Oct. 26, 1998, now abandoned.
(60) Provisional application No. 60/063,401, filed on Oct. 27, 1997.

(51) Int. Cl. E06B 9/00

(52) U.S. Cl. 160/38

(57) ABSTRACT

A support hook for adding decorations to window coverings such as window blinds. The support hook is capable of being positioned and held to a window blind valance without the need for additional mechanical fasteners. The support hook has a section which fits over the valance, a rear section which extends behind the valance and holds the support hook to the valance and a front section which extends in front of the valance and has a hook-like portion on the end thereof for holding a supplemental window decoration.

### BACKGROUND AND SUMMARY OF THE INVENTION

The present invention relates generally to new and novel improvements in a support hook for window blinds to hold and support supplemental window decorations thereon. More particularly, the present invention relates to a support hook for window blinds to hold and support supplemental window decorations thereon which is economical to fabricate, easy to use and attaches to the existing valance portion of a blind assembly to hold and support supplemental window decorations thereon.

It is desirable in many homes, as well as in commercial and industrial establishments, to decorate window blinds installed in windows with supplemental window decorations, such as floral arrangements, holiday decorations and decorative curtains. Such supplemental window decorations are often installed and held in place by an independent support member, such as a rod or some other support structure, which is attached to the window frame or to the surrounding wall by mechanical fasteners, such as screws. Such mechanical fasteners often require a drill to prepare “lead” holes and a screwdriver, or some other tool, to install the mechanical fasteners. This makes the procedure of installing supplemental window decorations on vertical blinds more difficult and labor intensive than. is desirable.

Accordingly, an object of the present invention is the provision of a support hook for window blinds which holds and supports supplemental window decorations thereon which is economical to fabricate, easy to use and attaches to the existing valance portion of a vertical blind assembly to hold and support supplemental window decorations thereon.

These and other objects of the present invention are attained by the provision of a support hook for window blinds, such as vertical blinds or venetian blinds, which holds and supports supplemental window decorations thereon which is fabricated from a plastic material and fits over the existing valance portion of a blind assembly to enhance the look of the existing valance portion by, for example, holding and supporting supplemental window decorations, such as floral arrangements, holiday decorations and decorative curtains, thereon. The support hook which holds and supports supplemental window decorations thereon in accordance with the present invention is slipped over the existing valance portion of a blind assembly to hold and support a rod, or some other support member. No tools or special hardware is needed for installation of the support hook for blinds which holds and supports supplemental window decorations thereon in accordance with the present invention and installation takes just seconds.

### BRIEF DESCRIPTION OF THE DRAWINGS

FIG. 1 is a side view of a support hook for use with a window blind valance in accordance with the present invention.

FIG. 2 is a perspective view of the support hook for use with window blinds in accordance with the present invention, the support hook being shown positioned on a window blind valance.

FIG. 3 is a perspective view of the support hook for use with window blinds two support hooks installed on a valance portion of a vertical blind assembly and having a floral arrangement mounted on a support member held and supported between the two support hooks.

### DETAILED DESCRIPTION OF THE DRAWINGS

In the following detailed description of a preferred embodiment of the present invention, reference is made to the accompanying drawings which, in conjunction with this detailed description, illustrate and describe a preferred embodiment of a support hook for window blinds which holds and supports supplemental window decorations thereon, generally identified by reference number 10, in accordance with the present invention. In the following description, “outwardly” refers to parts of the support hook which extend away from the valance and “inwardly” refers to parts of the support hook which extend towards the valance. In addition it should be understood that although the specification herein refers to vertical blinds, the support hook described herein may be used with other types of window blinds or curtain apparatus to add supplemental decorations thereto.

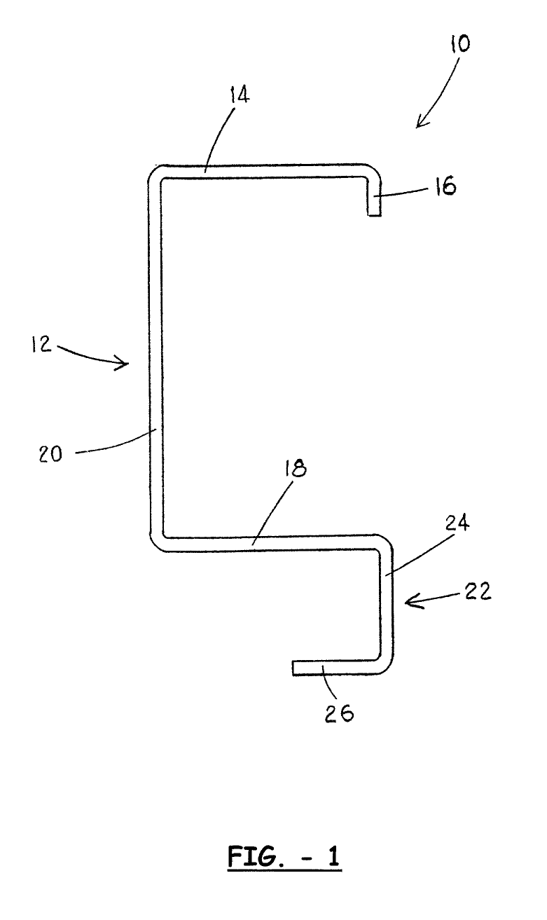

Referring to FIG. 1, support hook 10 is preferably fabricated from a plastic material such as a polycarbonate resin material such as LEXAN™. Other plastic materials may be used. The materials are preferably transparent or substantially transparent, but could also be made, if desired, in various decorative colors. As seen in FIG. 1, support hook 10 is substantially “S” shaped in configuration and includes upper section 12 which is dimensioned to fit over a top portion of an existing valance portion of a vertical blind. Upper section 12 includes rear portion 14 which fits over the rear surface of the existing valance portion of a vertical blind and inwardly extending retaining portion 16 which extends inwardly from the end of rear portion 14 and is dimensioned to fit or “hook” under the valance portion and top portion 20 which extends between rear portion 14 and front portion 18 and fits over the top surface of the valance portion of a window blind. Extending outwardly from front portion 18 is a hook portion 22, which may include outwardly extending portion 24 and upwardly extending portion 26. Hook portion 22 is preferably dimensioned to accept a rod, or some other support member. Hook portion may also have a U-shape for holding other types of decorative articles. The support hook of the present invention may also be used to support curtains or decorative fabric or floral arrangements which may be draped over the hook, as well as other types of decorations.

Support hook 10 can be fabricated in various widths. In a preferred embodiment, the width of the support hook is approximately 1 inch to approximately 3 inches. In addition, the various sections of the support hook could be varied in length to accommodate various shapes and sizes of window blinds. For instance, for standard vertical blinds, an upper section approximately 2 inches long will be sufficient to fit over the valance portion. In standard venetian blinds, the upper section could be 1 inch long to accommodate the valance. It is contemplated by the present invention that the upper portion of the support hook be adjustable, such as by having the front and rear portions slidably connected to one another such that the upper portion could be lengthened to fit over various sizes of valances. In addition, it is also contemplated that the front, rear and hook sections of the support hook may also be adjustable to accommodate various windows, blinds and types of decorations.

In one embodiment of the present invention, the front section of the support hook is at least slightly longer than the rear portion. This allows the hook portion which holds the decoration to potentially extend below the valance portion while the support hook is still securely held to the valance.

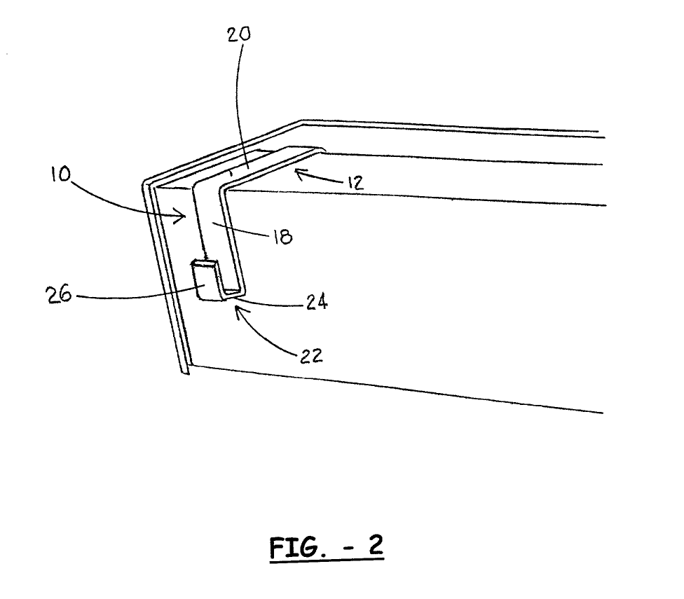

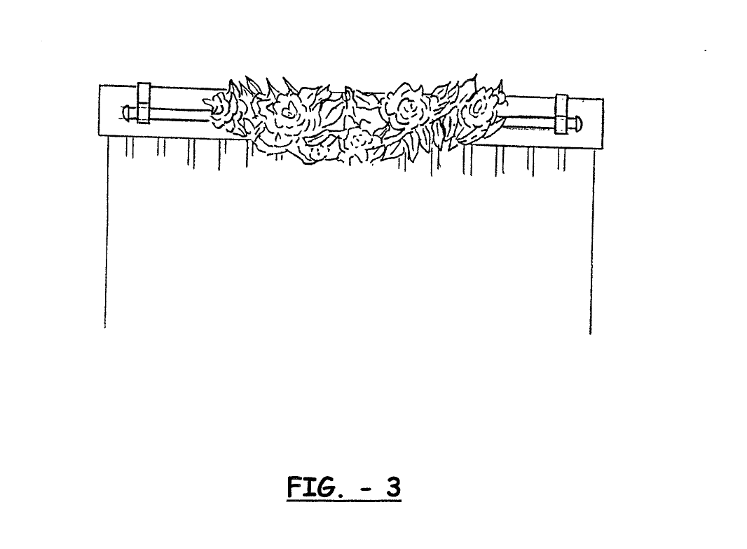

As seen in FIG. 2, support hook 10 is placed over the existing valance portion of a vertical blind by placing upper section 12 over the existing valance portion of a vertical blind. As seen in FIG. 3, a rod, or some other support member or decoration, is then placed in the support section 22 of support hook 10. Supplemental window decorations, such as floral arrangements, holiday decorations and decorative curtains, are then held in place on the rod, or some other support member, to decorate the existing valance portion of a vertical blind.

Although no additional means are necessary for connecting the support hook of the present invention to a valance, it is contemplated by the present invention that a means for positively connecting the retaining member or the rear portion to a valance may be used. Such a means may include any known fastening means such as screws, nails, clips or adhesives. In addition, the retaining member may also have an upwardly extending portion to create a hook-like portion to hold the support hook of the present invention onto a valance.

Although the present invention has been described above in detail, the same is by way of illustration and example only and is not to be taken as a limitation on the present invention. For example, various other materials, such as other plastics, metals or wood, could be utilized to produce support hook 10. Accordingly, the scope and content of the present invention are to be defined only by the terms of the appended claims.

What is claimed is:

1. A support hook for holding supplemental decorations to be attached to a window blind having a valance, said support hook comprising:
an upper section dimensioned to fit over said valance, said upper section having a first end and a second end;
wherein a front section extends downwardly from said first end of said upper section and wherein a rear section extends downwardly from said second end of said upper section;
a retaining member extending inwardly at least a short distance from an end of said rear section opposite said upper section; and
a hook portion, wherein said hook portion extends outwardly from said front section at an end of said front section opposite said upper section.

2. The support hook as recited in claim 1 wherein said hook portion comprises a support member, said support member extending outwardly from said end of said front section opposite said upper section and a holding member extending upwardly from an end of said support member opposite said front section.

3. The support hook as recited in claim 1 wherein said front section is at least slightly longer than said rear section.

4. The support hook as recited in claim 1 wherein said support hook is fabricated of plastic.

5. The support hook as recited in claim 1 wherein said support hook is approximately 1 inch to approximately 3 inches wide.

6. The support hook as recited in claim 1 wherein the length of said upper section between said first end and said second end is adjustable.

7. The support hook as recited in claim 1 wherein the length of said rear section between said upper section and said retaining member is adjustable.

8. The support hook as recited in claim 1 wherein the length of said front section between said upper section and said hook portion is adjustable.

9. The support hook as recited in claim 1 wherein said hook is transparent.

10. The support hook as recited in claim 1 further comprising:
a means for positively connecting said retaining member to said valance.

11. The support hook as recited in claim 1 further comprising:
a means for positively connecting said rear portion to said valance.
